(19) United States
(12) Patent Application Publication
(10) Pub. No.: US 2003/0126196 A1
(43) Pub. Date: Jul. 3, 2003

(54) System for optimizing the invocation of computer-based services deployed in a distributed computing environment

(76) Inventors: Todd Lagimonier, Delray Beach, FL (US); James Voris, Cockeysville, MD (US)

Correspondence Address: John W. Ryan, WILMER CUTLER & PICKERING, 2445 M. Street, N.W., Washington, DC, 20037-1420, US

(21) Appl. No.: 10/026,887

(22) Filed: Dec. 27, 2001

(51) Int. Cl. G06F 15/16

(52) U.S. Cl. 709/203; 709/226

(57) ABSTRACT

A method of optimization is utilized in a distributed environment. The method includes receiving a request and retrieving a plurality of services associated with the request. The method also includes packaging the plurality of services into a message object with data associated with the request and transmitting the message object to a first service of the plurality of services.

### FIELD OF THE INVENTION

The present invention relates generally to distributed computing systems, in particular improving performance in distributed computing systems.

### DESCRIPTION OF THE RELATED ART

Distributed computer networks are widely used. In a typical distributed computer network, server-type computers are geographically located over a wide area. The server-type computers are interconnected by a network. The network may be a local area network, a wireless network, a wide area network, or combination thereof. The server-type computers may also be configured to communicate with clients (or users) via a wired network, wireless network or combination thereof.

In the typical distributed computer network, the server-type computer provide application and/or data services to the clients. The server-type computers may have applications such as personal information software, electronic messaging software, or other similar software. The server-type computers may also provide services such as synchronization, automatic information transfer from predetermined data providers, or other similar services.

The typical distributed computer network has performance requirements to achieve such as uptime, expected throughput or other similar benchmark. In order to meet these performance requirements, network designers often specially configure the distributed computer network. For example, one manner of achieving expected throughput is to distribute enterprise applications throughout the distributed computer network. Specifically, each server-type computer may be configured to execute a subset of associated services with an enterprise application, thereby not concentrating requests for services to one specific server. For uptime requirements, each service may be duplicated on two or more computers, thereby providing redundancy for enterprise applications and, consequently, the distributed computer network. Accordingly, by distributing the enterprise applications, the enterprise application processing load may be spread among all the server-type computers and allow the application to continue processing should one of the server-type computers become unavailable.

Although distributing enterprise applications among various server-type computers promotes uptime for a distributed computer system, there may be some drawbacks or disadvantages. For example, an expensive aspect, i.e., costly in performance, of executing enterprise applications in a distributed computer environment is transferring information between server-type computers for execution of a selected service. In particular, if server A receives a request for a service X which is only provided by server B, server A's request for the service X by server B requires server A to gather or marshal and transfer the appropriate data for the requested service by server B. Moreover, server A may occur additional performance penalties waiting for server B to return with the appropriate data or service. Accordingly, the marshalling and transferring of data between remote computers may be one of the most expensive aspects of a distributed computer environment.

### SUMMARY OF THE INVENTION

In accordance with the principles of the present invention, one aspect of the invention pertains to a method of optimization in a distributed environment. The method includes receiving a request and retrieving a plurality of services associated with the request. The method also includes packaging the plurality of services into a message object with data associated with the request and transmitting the message object to a first service of the plurality of services.

Another aspect of the present invention relates to a method of optimization in a distributed environment. The method includes determining a service provider for a request for a current service and initiating the current service at a local service provider in response to the determination of the local service provider as a provider of the current service. The method also includes invoking a request for a subsequent service to the current service by the local service provider.

Yet another aspect of the present invention pertains to a system for optimization in distributed environment. The system includes a network, a plurality of clients configured to request services over the network, a plurality of data providers, each data provider configured to interface with the plurality of clients over the network and a service module. The service module is configured to be executed on each data provider of the plurality of data providers. The service module is also configured to retrieve a plurality of services associated with a received request and to package the plurality of services as an itinerary list into a message object. The service module is further configured to transmit the message object to a first service of the plurality of services.

Yet another aspect of the present invention relates to a computer readable storage medium on which is embedded one or more computer programs. The one or more computer programs implement a method of optimization in a distributed computing environment. The method includes determining a service provider for a request for a current service and initiating the current service at a local service provider in response to the determination of the local service provider as a provider of the current service. The method also includes invoking a request for a subsequent service to the current service by the local service provider.

Yet another aspect of the present invention pertains to a system for optimization in distributed environment. The system includes a network, a plurality of clients configured to request services over the network, a plurality of data providers, each data provider configured to interface with the plurality of clients over the network and a service module. The service module is configured to be executed on each data provider of the plurality of data providers. The service module is also configured to receive a message object configured to contain an itinerary list of services in response to a request from one of the plurality of service providers over the network. The service-chaining-module is further configured to perform an identified service on the itinerary list of services on a selected service provider of the plurality of service providers and to initiate a subsequent service to the identified service from the selected service provider.

### BRIEF DESCRIPTION OF THE DRAWINGS

Various features and aspects of the present invention can be more fully appreciated as the same become better understood with reference to the following detailed description of the present invention when considered in connection with the accompanying drawings, in which:

FIG. 1 illustrates an exemplary system where an embodiment of the invention may be practiced in accordance with an embodiment of the present invention;

FIG. 2 illustrates a block diagram of an architecture of a server shown in FIG. 1 in accordance with the principles of the present invention;

FIG. 3 illustrates a flow diagram for a operational mode of the service-chaining module in accordance with an embodiment of the present invention;

FIG. 4 illustrates an exemplary flow diagram for another operational mode for the service-chaining module in accordance with an embodiment of the present invention;

FIG. 5 illustrates an exemplary embodiment of a message class system in accordance with an embodiment of the present invention; and

FIG. 6 illustrates an exemplary block diagram of a computer system where an embodiment of the present invention may be practiced.

### DETAILED DESCRIPTION OF A PREFERRED EMBODIMENT

For simplicity and illustrative purposes, the principles of the present invention are described by referring mainly to an exemplary embodiment of a service-chaining module. However, one of ordinary skill in the art would readily recognize that the same principles are equally applicable to, and can be implemented in, all types of distributed computer systems, and that any such variation does not depart from the true spirit and scope of the present invention. Moreover, in the following detailed description, references are made to the accompanying drawings, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment of the present invention, a service-chaining module may be utilized to optimize the execution of enterprise applications in a distributed network environment. In particular, the service-chaining module may be configured to be executed by servers (or data/service providers) within the distributed network environment. The distributed network environment may be configured to support enterprise applications that provide services to clients. Each server within the distributed network environment may be configured to execute a subset of services for an enterprise application. In addition, each server may provide back-up service for another server's subset of services in order to maintain maximum availability of the enterprise application.

A server may receive a request from a client or from another server. The service-chaining module may be configured to determine a plurality of services associated with the received request. The service-chaining module may be also configured to generate an itinerary list of services associated with the received request. The service-chaining module may be further configured to instantiate a message object configured to include the itinerary list and data associated with the request. The service-chaining module may be further configured to transmit or forward the message object to a first server listed on the itinerary list, which may include the server generating the message object, for further processing.

In another aspect of the present invention, a server executing a service-chaining module may receive a message object from another server. The service-chaining module may be configured to execute or perform a service identified in a received message object. The service-chaining module may also be configured to preferentially select the receiving server to provide the identified service, i.e., the local server, versus a remote server. The service-chaining module may be further configured to invoke the identified service and to forward any data associated with the identified service from the message object to a service interface of the local server. As the service interface completes providing the identified service, the service-chaining module may be further configured to invoke a subsequent service identified in the message object.

If the service-chaining module on the receiving server determines that the identified service may only be provided by a remote server, the service-chaining module may forward the message object to the remote server. A service-chaining module executing on the remote server, i.e., the remote service-chaining module, may execute the identified service and invoke the next service without returning to the original receiving server. Accordingly, network traffic may be reduced between servers since a request for subsequent service may be initiated from a remote server without returning to the original calling server. Moreover, the service calls from remote servers are reduced since the service-chaining module preferentially selects local servers to the received message object versus remote servers, thereby further reducing network traffic and enhancing performance.

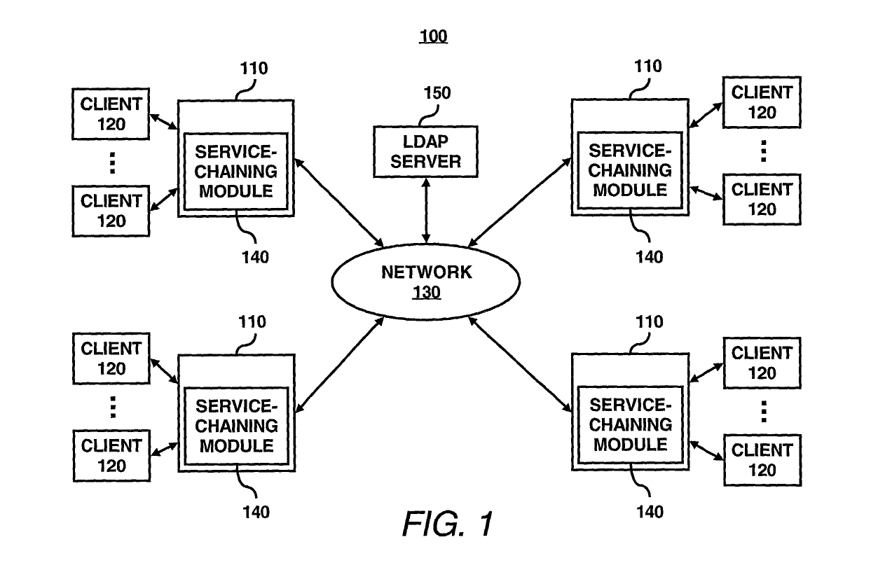

FIG. 1 illustrates an exemplary system 100 where an embodiment of the invention may be practiced in accordance with the principles of the present invention. As shown in FIG. 1, the system 100 includes servers 110 and clients 120. It should be readily apparent to those of ordinary skill in the art that FIG. 1 represents a generalized schematic illustration of the system 100 and that other components may be added or existing components may be removed or modified without departing from the spirit or scope of the present invention.

As shown in FIG. 1, the servers 110 may be configured to supply application software programs to the clients 120. The application software programs may be, but not restricted to, enterprise applications such as synchronization software, inventory tracking software, electronic messaging software and other similar collaborative application software. The servers may be also configured to supply data to the clients 120 in relation to the enterprise applications. The servers 110 may be implemented by a computer, a workstation, a mainframe computer or other similar computing platform.

The servers 110 may be further configured to interface with another over a network 130. The network 130 may be configured to provide a communication interface among the servers 110. The network 130 may be implemented as a wired network such as local area network, a token ring network, a wide area network, the Internet or some combination thereof. The network may be configured to support protocols such as Transmission Control Protocol/Internet Protocol, X.25, IEEE 802.5, IEEE 802.3, Asynchronous Transfer Mode, and other network protocols. The network 130 may be also implemented as a wireless network. The network 130 may be configured to support wireless network protocols such as Cellular Digital Packet Data, Mobitex, IEEE 801.11b, Wireless Application Protocol, Global System for Mobiles, and other similar protocols. Alternatively, the network 130 may be a combination of wired and wireless networks with the respective network protocols.

The clients 120 may be implemented by a text-pager, a personal digital assistant, a wireless mobile telephone with or without integrated displays, desktop computer or any device that may be interfaced with the network 130. Each of the clients 120 may be configured to execute a client program which may be implemented as a software program, utility and/or subroutine to interface with the servers 110. The client program may be configured to provide the functionality (e.g., utilities, application specific software, etc.,) to support session services.

A Lightweight Directory Access Protocol (LDAP) server 150 may be included in the system 100. The LDAP server 150 may be configured to provide directory services for the system 100. In particular, the LDAP server 150 may provide location information of services located with the system 100, i.e., which servers may provide which subsets of services for the enterprise applications. The LDAP 150 server may be implemented using conventional server-type computing platforms and/or replicated among the servers 110. Alternatively, functions of the LDAP 150 server may be performed by a relational database management program, a table or any other similar referencing data structure in one of the servers 110.

The servers 110 (or service providers) may execute an embodiment of a service-chaining module 140 in accordance with the principles of the present invention. The service-chaining module 140 may be configured to optimize network traffic in the system 100. Specifically, the service-chaining module 140 may be configured to reduce network packet traffic by utilizing an embodiment of the present invention, a service-chaining technique. The service-chaining module 140 may compile a list or table of services associated with a request from a client 120. The request may be a user logging into the system 100, a synchronization event, a secure communication request event, and other similar service event. The service-chaining technique formats the list of services in such a manner that a subsequent service on the list of associated services is initiated from a server that is servicing the current service on the list of associated services. By not returning from each service call to the original server, network packet traffic may be reduced by eliminating the overhead traffic associated with remote service calls common to conventional systems.

In another aspect, the service-chaining module 140 may be configured to optimize network packet traffic by preferentially selecting local service providers, i.e., a server local to the service-chaining module 140. Specifically, the service-chaining module 140 may be configured to select servers 110 to provide the associated services of a request. Since each server 110 may be configured to provide a subset of services of an application software program and a redundant (or back-up) subset of services of another server, there is a possibility that an associated service may be located on a local and a remote server 110. By preferentially selecting a local server for an associated service of a request, the network packet traffic may be reduced since requests for services to remote servers are minimized.

In yet another aspect, the service-chaining module 140 may be configured to organize the list of associated services of a request in such a manner that the path between the selected remote servers is the shortest path. The service-chaining module 140 may use spanning tree algorithms, traveling salesman algorithms, etc., to determine the shortest path for the list of associated services.

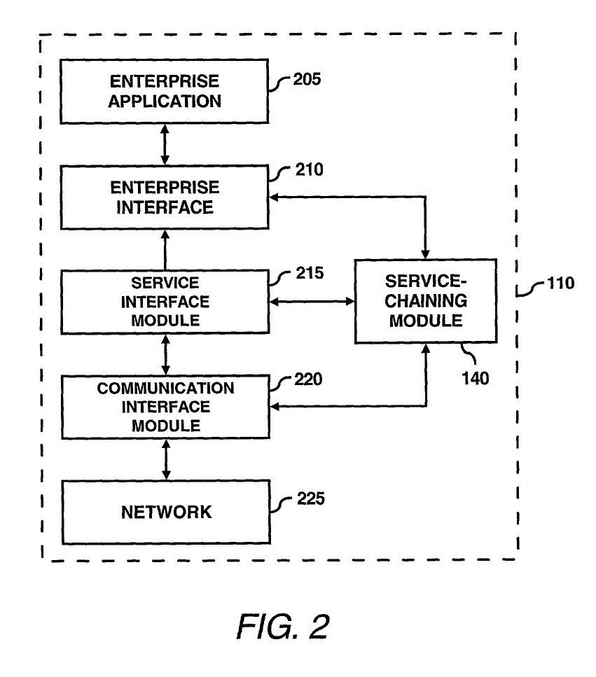

FIG. 2 illustrates a block diagram of an architecture of a server 110 shown in FIG. 1 in accordance with an embodiment of the present invention. As shown in FIG. 2, the server 110 may include an enterprise application 205, an enterprise interface module 210 (labeled as enterprise interface in FIG. 2), a service interface module 215, a communication interface module 220, a network interface 225 and an embodiment of the service-chaining module 140. It should be readily apparent to those of ordinary skill in the art that FIG. 2 represents a generalized schematic illustration of the server 110 and that other components may be added or existing components may be removed or modified without departing from the spirit or scope of the present invention.

The enterprise application 205 of the server 110 may be configured to provide the application software programs for the clients 120 (shown in FIG. 1). The enterprise application 205 may be an instant messaging program, a time/expense management tools, an enterprise-resource planning program, a sales force automation program, a database queries, Web browsing, calendaring program or other similar program.

The enterprise application 205 may be also configured to interface with the enterprise interface module 210. The enterprise interface module 210 may be configured to provide data interface to services such as synchronization, streaming, real-time data access, transaction-based messaging, etc., for the enterprise application 205.

The enterprise interface module 210 may be further configured to interface with the service interface module 215. The service interface module 215 may be configured to provide services to the clients 120 and to the enterprise application 205 such as authentication, security and encryption, compression, billing, network and user management, presence-sensing, fail-over, etc. The service interface module 215 may be also configured to interface with the service-chaining module 140.

The service-chaining module 140 may also be configured to interface with the enterprise interface module 210. Typically, the enterprise interface module 210 may invoke the service-chaining module 140 in response to a request. A request may be an alert generated by an enterprise application in response to a user-defined event, an informational query, or other communication message between the servers 110.

In one aspect of the present invention, the services provided by the service interface module 215 may be a subset of the total services provided by the system 100, include on the services are back-up services for other another subset of services. For example, a server 110 (shown in FIG. 1) may provide authentication, compression, and billing services as well as being a back-up server for network and user management services.

The service interface module 215 may be further configured to interface with the communication interface module 220. The communication interface module 220 may be configured to convert information (data, commands, etc.) between the service interface module 215 and the network interface 225. The communication interface module 220 may be also configured to interface with the service-chaining module 140 to receive a message object from the service-chaining module 140.

The network interface 225 may be configured to provide a communication interface to a network, such as the network 130 shown in FIG. 1. The network interface 225 may be configured to support networks such as voice, Wireless Application Protocol, Short Message Service, Transmission Control Protocol/Internet Protocol, and other similar wireless protocols.

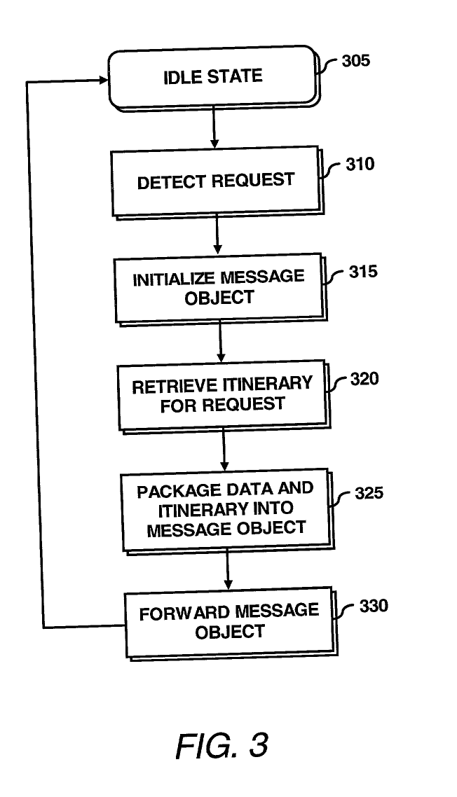

FIG. 3 illustrates a flow diagram for a first operational mode 300 of the service-chaining module 140 in accordance with an embodiment of the present invention. Specifically, the first operational mode 300 relates to an instantiation of a message object. It should be readily apparent to those of ordinary skill in the art that the flow diagram 300 depicted FIG. 3 represents a generalized schematic illustration of the first operational mode for the service-chaining module 140 and that other steps may be added or existing steps may be removed or modified without departing from the spirit or scope of the present invention.

As shown in FIG. 3, the service-chaining module 140 may be configured to be in an idle state, in step 305. Although in the idle state, the service-chaining module may be monitoring the enterprise interface 210 for incoming requests from clients and/or monitoring the communication interface module 220 for incoming message objects. The service-chaining module 140 may be also configured to detect a request from a client through the enterprise interface 210, in step 310.

In step 315, the service-chaining module 140 may be configured to initialize or instantiate a message object, which is described in greater detail herein below. In accordance to an embodiment of the present invention, the message object is a data structure instantiated by the service-chaining module 140 that is forwarded among the servers of the system 100 in order to implement the received request.

In step 320, the service-chaining module 140 may be configured to retrieve an itinerary of services associated with the received request, i.e., a list of services to fulfill the received request. The service-chaining module 140 may reference a configuration data structure (e.g., a file, a database, a table, or other similar referencing structure). The configuration data structure may be filled with pre-determined data by a system administrator. Each entry in the configuration data structure may include a universal resource identifier (URI) to identify the service. The configuration data structure may be stored in a memory local to the service-chaining module 140 or in a location accessible by all the servers in the system 100.

In step 325, the service-chaining module 140 may be configured to package the associated services, i.e., an itinerary list, along with any necessary data from the request into the message object. Subsequently, the service-chaining module 140 may forward the message object to the first service on the itinerary list for execution, in step 330, and then return to the idle state of step 305.

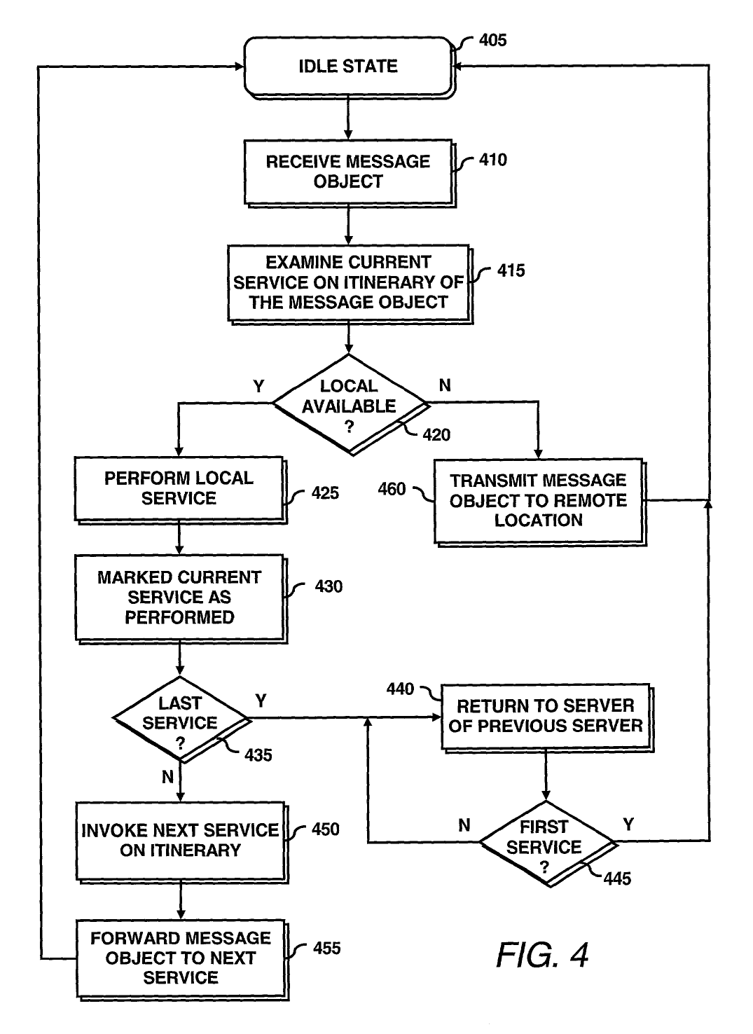

FIG. 4 illustrates an exemplary flow diagram 400 for a second operational mode for the service-chaining module 140. Specifically, the second operation mode relates to processing of a received message object. It should be readily apparent to those of ordinary skill in the art that the flow diagram 400 FIG. 4 represents a generalized schematic illustration of the second operational mode for the service-chaining module 140 and that other steps may be added or existing steps may be removed or modified without departing from the spirit or scope of the present invention.

As shown in FIG. 4, the service-chaining module 140 may be configured to be in idle state, in step 405. Although in the idle state, the service-chaining module 140 may be monitoring the communication interface module 220 (as shown in FIG. 2) for incoming message objects. In step 410, the service-chaining module 140 may detect an incoming message object via the communication interface module 220, in step 410.

In step 415, the service-chaining module 140 maybe configured to identify the current service on the itinerary list of the received message object. Specifically, the service-chaining module 140 may retrieve a URI for the current service and make a determination if a local instance of the current service is local to the service-chaining module 140 that received the message object. The service-chaining module 140 may refer to a local configuration data structure that identifies the services local to the service-chaining module 140 to determine if the identified service is local, in step 420. Alternatively, the service-chaining module 140 may refer to a central configuration data structure that lists the services associated with each server in the system 100. For example, the service-chaining module 140 may send a message to the LDAP server 150 to request location information on the location of which server provides the requested service.

If the identified service is local, the service-chaining module 140 may pass any associated data with the identified service to the service interface module 215 to perform the local service, in step 425. The service-chaining module 140 may mark the current service as performed so as to prevent a repetition of the current service, in step 430.

In step 435, the service-chaining module 140 may be configured to determine if the current service is the last service on the itinerary list of the message object. If the current service is the last service, the service-chaining module 140 may return the message object to the previous server that initiated the current service, in step 440. The service-chaining module 140 may be yet further be configured to determine if the first service on the itinerary list has been reached, in step 445. If the first service has not been reached, the service-chaining module 140 may go to the processing of step 440. Otherwise, if the first service has been reached, the service-chaining module 140 may return to the idle state of step 405.

Otherwise, if the current service is not the last service, the service-chaining module 140 may be configured to invoke a service subsequent to the current service on the itinerary list of the message object, in step 450. Then, in step 455, the service-chaining module 140 may also be configured to forward the message object to the subsequent service.

Returning to step 420, if the service-chaining module 140 determines that a local server cannot provide the service, the service-chaining module 140 may be configured to transmit the message object to the remote server, in step 460. Subsequently, the service-chaining module 140 returns to an idle state of step 405.

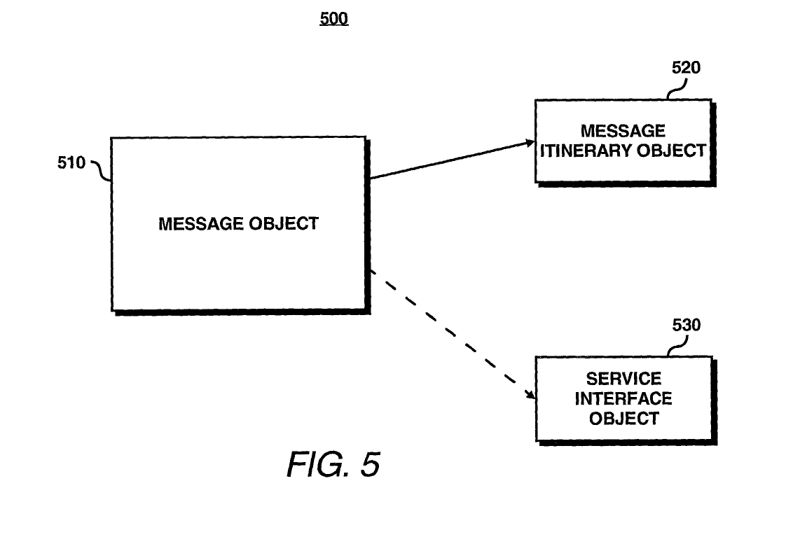

FIG. 5 illustrates an exemplary embodiment of a message object system 500 in accordance with an embodiment of the present invention. It should be readily apparent to those of ordinary skill in the art that FIG. 5 represents a generalized schematic illustration of the message object system 500 and that other attributes and/or methods may be added or existing attributes and/or methods may be removed or modified without departing from the spirit or scope of the present invention.

As shown in FIG. 5, the message object system 500 includes a message object 510, a message itinerary object 520, and a service interface 530. The message object 510 maybe an instantiation of a message class. The message class may include methods that traverse an itinerary, package data associated with a request, invoke a subsequent service on the itinerary, etc.

Associated with the message object, is a message itinerary object 520. The message itinerary object 520 may be an instantiation of a message itinerary class. The message itinerary class may be configured to list an itinerary of services associated with a request and methods to traverse the itinerary.

The service interface object 530 may also be associated with the message object 510. The service interface object 530 may be configured to provide an interface for a service-chaining module to pass data to perform the requested service.

Accordingly, a service-chaining module 140 executing on a server 110 (shown in FIG. 1) may instantiate a message object from the message class 500 in response to receiving a request from a client 120. The service-chaining module 140 may instantiate a message itinerary object from the message itinerary class 520. The message itinerary object may be configured, by executing the associated methods, to generate an itinerary of service interfaces that the message object has to visit to satisfy the received request.

After the message itinerary message object is completed, the message object is forwarded to the first service-chaining module which invokes the first service interface on the message itinerary for the associated service. Subsequently, as the current service is completed at a current service interface, the service-chaining module is configured to invoke the next service interface on the message itinerary object. This chaining of the services continues until the last service interface is reached on the message itinerary object.

In another aspect of the present invention, as the service-chaining module is invoking the next service from a current service, the service-chaining module in selecting which service interface to invoke preferentially selects a local service interface over a remote service interface. Accordingly, network packet traffic is reduced by reducing the number of remote calls.

The message object system 500, as described herein above, may be implemented using a variety of object-oriented programming languages such as JAVA, C++, C, VISUAL BASIC, etc.

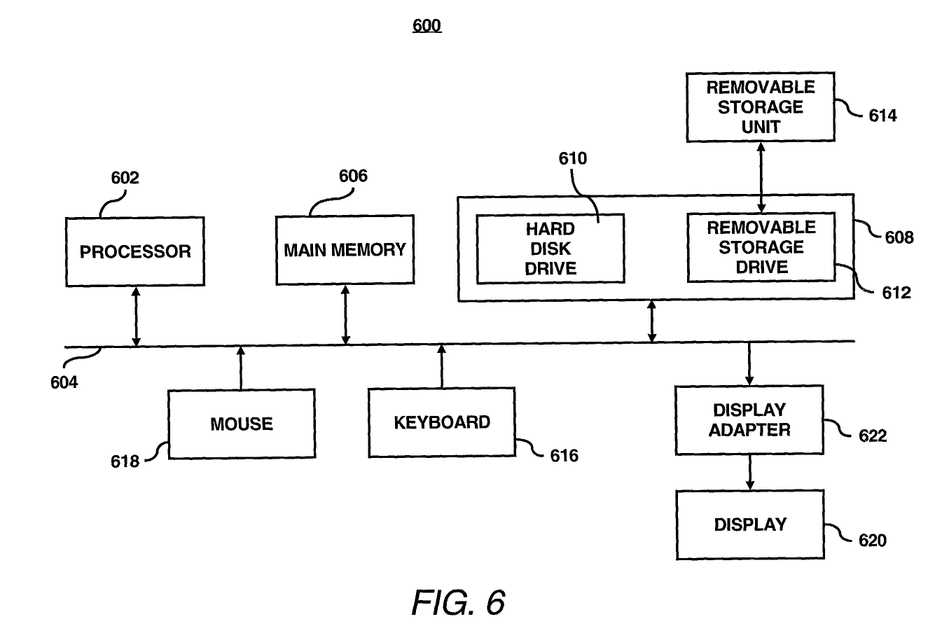

FIG. 6 illustrates an exemplary block diagram of a computer system 600 where a preferred embodiment of the present invention may be practiced. The functions of the present invention may be implemented in program code and executed by the computer system 600. The service-chaining module 140 may be implemented in computer languages such as PASCAL, C, C++, JAVA, etc.

As shown in FIG. 6, the computer system 600 includes one or more processors, such as processor 602 that provides an execution platform for the service-chaining module 140. Commands and data from the processor 602 are communicated over a communication bus 604. The computer system 600 also includes a main memory 606, preferably Random Access Memory (RAM), where the software for the service-chaining module 140 may be executed during runtime, and a secondary memory 608. The secondary memory 608 includes, for example, a hard disk drive 610 and/or a removable storage drive 612, representing a floppy diskette drive, a magnetic tape drive, a compact disk drive, etc., where a copy of a computer program embodiment for the service-chaining module 140 may be stored. The removable storage drive 612 reads from and/or writes to a removable storage unit 614 in a well-known manner.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method of optimization in a distributed environment, said method comprising:
receiving a request;
retrieving a plurality of services associated with said request;
packaging said plurality of services into a message object with data associated with said request; and
transmitting said message object to a first service of said plurality of services.

2. The method according to claim 1, further comprising:
receiving said message object;
determining a service provider for said first service of said plurality of services;
initiating said first service with data associated with said first service at said local service provider in response to a determination of said local service provider as a provider of said first service; and
initiating a subsequent service to said first service from said local service provider.

3. The method according to claim 1, further comprising:
receiving said message object;
determining a service provider for said first service of said plurality of services; and
transmitting said message object to a remote service provider in response to said determination of said remote service provider as a provider of said first service.

4. The method according to claim 1, wherein said generation of plurality of services associated with said request comprises:
determining said plurality of services associated with said request from a profile;
determining an associated service provider for each service of said plurality of services associated with said request; and
selecting said associated service provider that is local for each service of said plurality of services associated with said request.

5. The method according to claim 4, further comprising:
packaging said plurality of services associated with said request and associated data providers into an itinerary; and
forwarding said itinerary to a first associated service provider of said first service of said plurality of services associated with said request.

6. The method according to claim 5, further comprising:
completing said first service on said first associated service provider; and
initiating said second service from said first associated service provider in response to said completion of said first service.

7. A method of optimization in a distributed environment, the method comprising:
determining a service provider for a request for a current service;
initiating said current service at a local service provider in response to said determination of said local service provider as a provider of said current service; and
invoking a request for a subsequent service to said current service by said local service provider.

8. The method according to claim 7, further comprising:
transmitting said request for a current service to a remote service provider in response to said determination of said remote service provider as a provider of said current service.

9. The method according to claim 8, further comprising:
invoking a request for a subsequent service to said current service by said remote service provider.

10. A system for optimization in distributed environment, said system comprising:
a network;
a plurality of clients configured to request services over said network;
a plurality of service providers, each service provider configured to interface with said plurality of clients over said network; and
a service module configured to be executed on each service provider of said plurality of service providers, wherein said service module is configured to retrieve a plurality of services associated with a received request and is also configured to package said plurality of services as an itinerary list into a message object, and is further configured to transmit said message object to a first service of said plurality of services.

11. The system according to claim 10, wherein said service module is further configured to generate an itinerary object containing said plurality of services associated with said request and said associated data provider for each service of said plurality of services associated with said request.

12. The system according to claim 11, wherein said itinerary object is an instantiation of an itinerary class.

13. The system according to claim 12, wherein said itinerary class is implemented using an object oriented programming language.

14. The system according to claim 11, wherein said service module is further configured to generate a message object configured to contain said itinerary object.

15. The system according to claim 14, wherein said service module is further configured to forward said message object to a selected service provider of said plurality of service providers.

16. The system according to claim 10, further comprising:
a service interface configured to be executed on each service provider of said plurality of service providers, wherein said service interface is configured to perform a selected service on said itinerary object.

17. The system according to claim 10, wherein said service module is further configured to receive said message object, to determine a service provider for said first service of said plurality of services, to initiate said first service with data associated with said first service at said local service provider in response to a determination of said local service provider as a provider of said first service and to initiate a subsequent service to said first service from said local service provider.

18. The method according to claim 10, wherein said service module is further configured to receive said message object, to determine a service provider for said first service of said plurality of services, and to transmit said message object to a remote service provider in response to said determination of said remote service provider as a provider of said first service.

19. A computer readable storage medium on which is embedded one or more computer programs, said one or more computer programs implementing a method of optimization, said one or more computer programs comprising a set of instructions for:
determining a service provider for a request for a current service;
initiating said current service at a local service provider in response to said determination of said local service provider as a provider of said current service; and
invoking a request for a subsequent service to said current service by said local service provider.

20. The computer readable storage medium in according to claim 19, said one or more computer programs further comprising a set of instructions for:
transmitting said request for a current service to a remote service provider in response to said determination of said remote service provider as a provider of said current service.

21. A system for optimization in distributed environment, said system comprising:
a network;
a plurality of clients configured to request services over said network;
a plurality of service providers, each service provider configured to interface with said plurality of clients over said network; and
a service-chaining module configured to receive a message object configured to contain an itinerary list of services in response to a request from one of said plurality of service providers over said network, wherein said service-chaining-module is configured to perform a identified service on said itinerary list of services on a selected service provider of said plurality of service providers and is also configured to initiate a subsequent service to said identified service from said selected service provider.

22. The system according to claim 21, wherein said selected service provider is preferentially selected to be local to said service-chaining module.

23. The system according to claim 22, wherein said service-chaining module is configured to reference a configuration data structure to determine said selected service provider.

24. The system according to claim 23, wherein said configuration data structure is local to said service-chaining module.

25. The system according to claim 23, wherein said configuration data structure includes an LDAP server.
